(19) United States
(12) Patent Application Publication
(10) Pub. No.: US 2024/0140222 A1
(43) Pub. Date: May 2, 2024

(54) SOCKETS AND CHARGING CABINETS FOR ELECTRIC VEHICLES

(71) Applicant: ABB E-mobility B.V., Delft (NL)

(72) Inventors: Pan CHEN, Shanghai (CN); Vincent-Cong WEI, Shanghai (CN); Sven QI, Den Haag (NL); Xiao Fei XIE, Shanghai (CN)

(21) Appl. No.: 18/496,413

(22) Filed: Oct. 27, 2023

(30) Foreign Application Priority Data
Oct. 27, 2022 (CN) CN202211326132.4

(51) Int. Cl. B60L 53/16; H01R 13/625

(52) U.S. Cl. CPC B60L 53/16; H01R 13/625

(57) ABSTRACT

The present disclosure relates to a socket with a fixing device and a charging cabinet for electric vehicles with the socket. The fixing device includes a connection mechanism, which is provided on one side of a mainbody of the socket and is adapted to releasably connect the socket to a mounting object to which the socket is to be mounted by means of a first fixing member, and a pivot mechanism, which is provided between the other side of the mainbody opposite to the connection mechanism and the mounting object, so that the socket is pivotable relative to the mounting object when released from the mounting object. Through the fixing device for the electric vehicle charging gun socket, the charging gun socket can be easily and quickly fixed on a mounting object, such as a charging cabinet, since the number of required fixing parts is reduced.

### CROSS REFERENCE TO RELATED APPLICATIONS

This patent application claims the benefit and priority of Chinese patent application No. 202211326132.4 filed on Oct. 27, 2022, the disclosure of which is incorporated by reference herein in its entirety as part of the present application.

### BACKGROUND

The present disclosure relates to the field of electric vehicles, in particular to a socket for an electric vehicle charging gun and a charging cabinet for electric vehicles.

In recent years, electric vehicles have become increasingly widely used. Electric vehicles receive power from the grid through a charging gun. The charging gun is inserted into the socket when not in use, and the socket is fixed on the charging cabinet. At present, sockets are generally provided with fixing holes at their four corners. When fixing, four bolts or screws are inserted into these fixing holes and screwed into the corresponding eyelets on the charging cabinet to fix the charging gun socket on the charging cabinet.

However, this kind of charging gun socket is more complicated to fix on the charging cabinet because it requires up to four screws, which is also time-consuming. In addition, for example, when the charging gun socket is removed from the charging cabinet for maintenance and inspection, since the socket has been separated from the charging cabinet, another location needs to be found to place the socket, and thus the socket will be difficult to find and potentially contaminated. Moreover, for example, after the charging gun is removed from its socket for charging an electric vehicle, the socket is exposed, making it easy for water, dust, etc. to enter the socket, causing potential short circuits and other safety hazards.

### BRIEF DESCRIPTION

Embodiments of the present disclosure provide a socket with a fixing device, which at least partially solves the aforementioned problems of the prior art.

In order to achieve the above, according to the present disclosure, the socket includes a fixing device, the fixing device including a connection mechanism, which is provided on one side of a mainbody of the socket and is adapted to releasably connect the socket to a mounting object to which the socket is to be mounted by means of a first fixing member, and a pivot mechanism, which is provided between the other side of the mainbody opposite to the connection mechanism and the mounting object, so that the socket is pivotable relative to the mounting object when released from the mounting object.

Through the socket with the fixing device according to the present disclosure, the charging gun socket can be easily and quickly fixed on a mounting object, such as a charging cabinet, since the number of required fixing parts is reduced. In addition, when the socket is loosened from the charging cabinet, the socket will not be separated from the mounting object, but will still hang on the mounting object, since the socket can pivot relative to the mounting object. Therefore, there is no need to find another location to place the socket, and the socket will not be contaminated by being placed elsewhere.

In one embodiment of the present disclosure, the connection mechanism includes a first through hole, and the first fixing member is adapted to extend into the mounting object through the first through hole, so that the connection mechanism is releasably connected to the mounting object. Here, since the insertion object, such as the charging gun can be fixed to the mounting object using only one fixing member, namely the first fixing member, only this one fixing member is required to be removed when releasing the insertion object from the mounting object. Therefore, the installation and removal of the insertion object such as charging gun sockets is greatly simplified, and the required time is significantly shortened.

In one embodiment of the present disclosure, the pivot mechanism includes a first pivot part, which is provided on the mainbody, a second pivot part, which is fixed on the mounting object by means of a second fixing member, wherein the first pivot part and the second pivot part cooperate with each other, so that the mainbody is pivotable relative to the mounting object when the first fixing member is removed. In this way, the socket can be pivoted relative to the mounting object in a simple manner.

In one embodiment of the present disclosure, the first pivot part includes two first wings, each first wing including a first pivot eyelet, and the second pivot part includes two second wings, each second wing includes a second pivot eyelet, the pivot mechanism further includes a pivot pin passing through the first pivot eyelet and the second pivot eyelet that are aligned with each other, so that the first pivot part is pivotable about the pivot pin relative to the second pivot part, and the socket is thus pivotable relative to the mounting object.

In one embodiment of the present disclosure, the pivot mechanism further includes a locking member passing through a locking eyelet on a free end of the pivot pin to prevent the pivot pin from falling off, and thereby preventing the socket from falling off the mounting object.

In one embodiment of the present disclosure, the second pivot part includes a second through hole, and the second fixing member is adapted to extend into the mounting object through the second through hole, so that the second pivot part is fixedly connected to the mounting object. In this way, it is guaranteed that the socket is permanently suspended on the mounting object without falling off under any circumstances, that is, whether the socket is released or whether an insertion object such as a charging gun is used.

In one embodiment of the present disclosure, the socket is a socket for an electric vehicle charging gun, and the mounting object is a charging cabinet of the electric vehicle charging gun.

In one embodiment of the present disclosure, the socket further includes a recess part, which is adapted to at least partially accommodate an insertion object, and a flip cover, which is adapted to seal the recess part. For example, when the charging gun is unplugged from the socket to charge an electric vehicle, the flip cover is used to seal the exposed socket to prevent water, dust, etc. from entering the socket and avoid potential safety hazards such as short circuits.

In one embodiment of the present disclosure, the socket further includes a flip base provided on its mainbody, and the flip cover is connected to the flip base through a connecting pin and is swingable relative to the flip base. In this way, the connection between the flip cover and the flip base and the swing of the flip cover are simply realized.

In one embodiment of the present disclosure, the connecting pin passes through a torsion spring, and the flip cover can automatically spring up by means of the torsion spring. In this way, the flip cover can automatically spring up under the elastic force of the torsion spring.

In one embodiment of the present disclosure, the flip cover includes a button, the flip base includes a snap mechanism, and the button is adapted to lock with the snap mechanism. Through the locking of the button and the snap mechanism, the flip cover can reliably seal the recess part of the socket.

In one embodiment of the present disclosure, the snap mechanism includes a button spring, and the button is pre-tensioned and locked with the snap mechanism by means of the button spring. Through this pre-tensioned lock, when the button is pressed, the lock can be easily released, allowing the flip cover to spring up automatically.

In one embodiment of the present disclosure, the flip cover includes a sealing ring on its inner side facing the flip base, and the sealing ring is adapted to sealed contact with the flip base. The sealing ring is used to reliably seal the flip cover relative to the flip base, thereby further reliably preventing water, dirt, etc. from entering the socket.

In one embodiment of the present disclosure, the flip base includes a sealing gasket on its bottom side facing the mainbody, and the sealing gasket is adapted to sealed contact with the mainbody. The sealing gasket further improves the sealing of the socket.

According to another aspect, the present disclosure also relates to a charging cabinet for electric vehicles, which includes the above-mentioned socket for the charging gun of electric vehicle. The aspects and advantages described above with respect to the socket for the charging gun of electric vehicle are correspondingly also applicable to the charging cabinet of electric vehicle, and the details are omitted here.

### BRIEF DESCRIPTION OF THE DRAWINGS

Other advantages and designs of the present disclosure are described in detail below with reference to the accompanying drawings, wherein:

FIG. 1A is a front view of a socket for an electric vehicle charging gun according to the present disclosure;

FIG. 1B is a top view of a socket for an electric vehicle charging gun according to the present disclosure;

FIG. 1C is a back view of a socket for an electric vehicle charging gun according to the present disclosure;

FIG. 2 is a perspective view of a socket for an electric vehicle charging gun according to the present disclosure;

FIG. 3A is a side view of a socket for an electric vehicle charging gun according to the present disclosure when it is pivoted at a certain angle;

FIG. 3B is a perspective view of a socket for an electric vehicle charging gun according to the present disclosure when it is pivoted at a certain angle;

FIG. 3C is a perspective view of a socket for an electric vehicle charging gun according to the present disclosure when it is pivoted at a certain angle and the flip cover is sprung up;

FIG. 4 is a pivot illustration of a socket for an electric vehicle charging gun according to the present disclosure;

FIG. 5 is a schematic illustration of another design of a socket for an electric vehicle charging gun according to the present disclosure;

FIG. 6A is a schematic illustration of the socket of another design according to FIG. 5 when it is not flipped up; and

FIG. 6B is a schematic illustration of the socket of another design according to FIG. 5 when it is flipped up.

### DETAILED DESCRIPTION

Corresponding reference signs and symbols in the different figures generally refer to corresponding regions, unless otherwise indicated. The figures are drawn to clearly illustrate the relevant aspects of the embodiments and are not drawn to scale. The edges of features in the figures do not necessarily denote the end of the range of the feature.

In the following description, various specific details are shown in order to provide a thorough understanding of various examples of embodiments according to the description. Embodiments may be implemented without one or more of the specific details, or with other methods, components, materials, etc. In other instances, known structures, materials, or operations are not shown or described in detail but do not affect the embodiments.

As used throughout the specification, the term “an embodiment” or “one embodiment” is intended to indicate that a specific configuration, structure, or characteristic described with respect to the embodiment is included in at least one embodiment. Thus, the terms such as “in an embodiment” “in one embodiment” that may appear in various aspects of this specification do not necessarily all refer to exactly the same embodiment. Furthermore, specific configurations, structures or characteristics may be combined in any suitable manner in one or more embodiments.

The reference signs used herein are provided for the convenience of reading, and thus do not limit the scope of protection or the scope of the embodiments. Identical or similar elements are identified with the same reference sign.

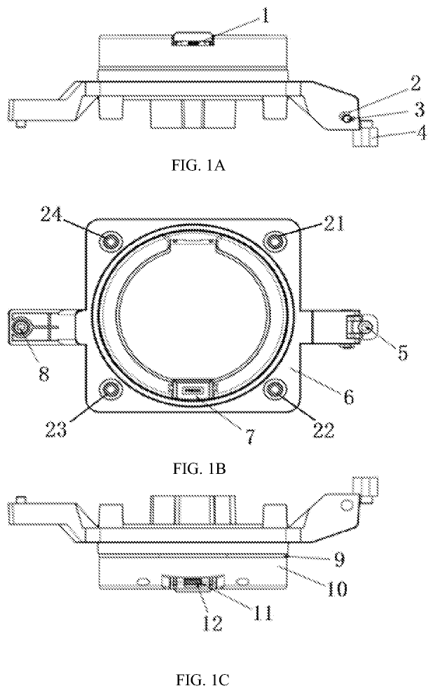

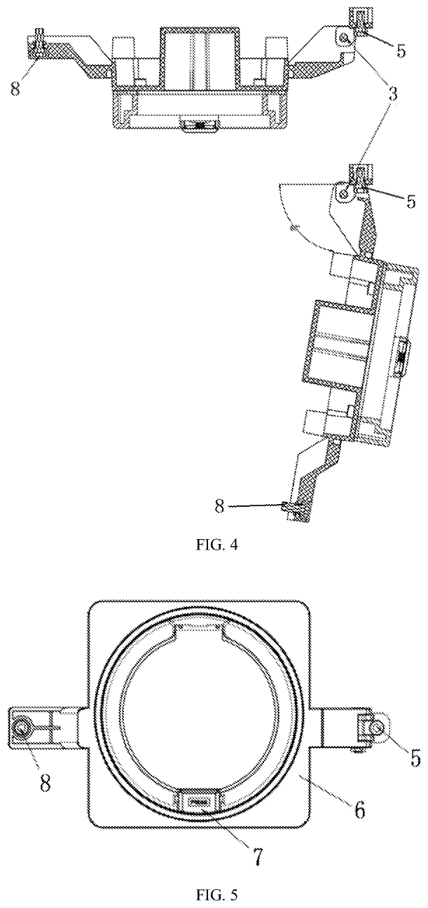

Exemplary embodiments according to the present disclosure are described in detail below with reference to FIGS. 1A to 5. First of all, it needs to be understood that the socket with a fixing device in the present disclosure can be used in a variety of fields, may be but not limited to a charging gun for electric vehicles. The present disclosure will be exemplarily introduced below by taking the charging gun of an electric vehicle as the insertion object and the charging cabinet of the electric vehicle as the mounting object to which the socket is to be plugged. During the charging, the electric vehicle obtain power from the power grid by means of a charging gun and a charging cabinet. The charging gun is inserted into the socket when not in use, in particular at least partially inserted into the recess 17 of the socket. The socket also has a mainbody 6 which is fixed on the charging cabinet. In one design, fixing holes 21, 22, 23, 24 are arranged on the mainbody 6, for example at its four corners. When fixing, four bolts or screws are inserted into these fixing holes 21, 22, 23, 24 respectively, and are screwed into the corresponding eyelets on the charging cabinet to fix the charging gun socket on the charging cabinet.

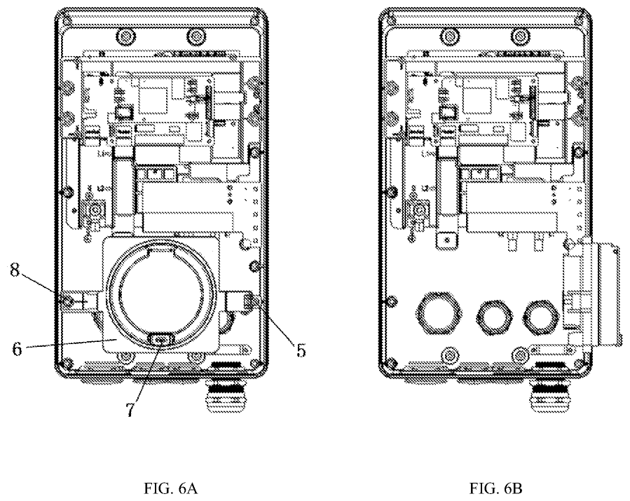

As mentioned before, this fixing method requires a large number of fixing parts, namely up to four bolts or screws. The mounting and removal of the charging gun socket is complicated and time-consuming. The present disclosure does not use these fixing holes 21, 22, 23, 24, but uses a simple fixing method, as shown in FIGS. 1A to 4. The present disclosure can also fundamentally eliminate these fixing holes, as shown in FIGS. 5-6B. FIG. 5 shows a socket without fixing holes according to the present disclosure. FIG. 6A shows the mounting situation of the socket without fixing holes according to the present disclosure of FIG. 5 which is used for the charging cabinet for electric vehicle charging gun, wherein the socket is not flipped up. FIG. 6B shows the situation when the socket is flipped up. Thus, the present disclosure provides a fixing device for an electric vehicle charging gun socket. The fixing device includes a connection mechanism 15. The connection mechanism 15 is provided on the mainbody 6 of the socket and is located on one side of the mainbody 6. For example, it is provided integrally with the mainbody 6, or is fixed on the mainbody 6. The connection mechanism 15 has a small number of first through holes 151, such as two or three, preferably only one first through hole 151, so that only one first fixing member 8 extends into the charging cabinet through the first through hole 151. Thus, the connection mechanism 15 is releasably connected to the charging cabinet. Here, the first fixing member 8 may be, for example, a bolt or a screw, which passes through the first through hole 151 and is screwed into a corresponding screw hole in the charging cabinet. Then, the socket is releasably connected to the charging cabinet of the electric vehicle using only a small number of the first fixing member 8, for example two or three, may be only one. As a result, the number of fixing members is reduced, the time required for mounting and removal of the socket is greatly shortened, and simple and rapid mounting and removal of the socket is realized.

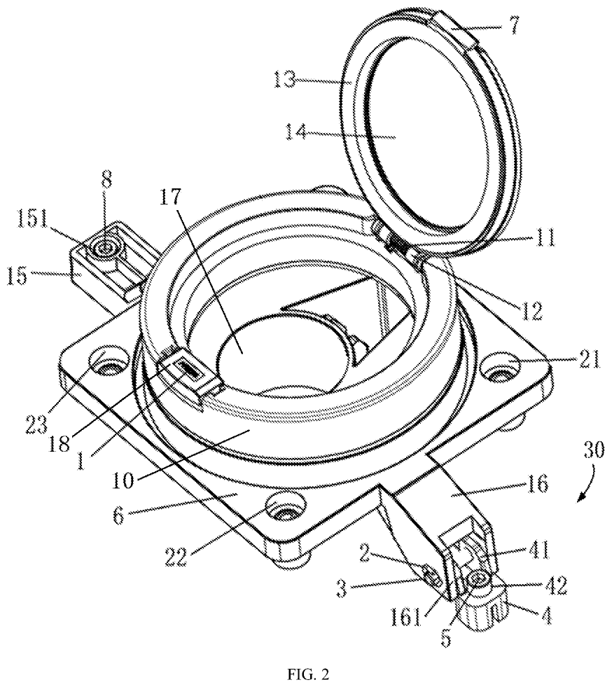

In one embodiment of the present disclosure, as shown in FIG. 2, the fixing device also includes a pivot mechanism 30, which is provided between the mainbody 6 and the charging cabinet on the other side opposite to the connection mechanism 15. The pivot mechanism 30 has a first pivot part 16 and a second pivot part 4. The first pivot part 16 is provided on the mainbody 6, for example it is provided integrally with the mainbody 6 or is fixedly connected to the mainbody 6. The second pivot part 4 is fixed on the charging cabinet using only a small number of second fixing member 5, may be only one. Specifically, the second pivot part 4 has only a small number of second through hole 42, may be only one, so that only one second fixing member 5 extends into the charging cabinet through only one second through hole 42. Here, the second fixing member 5 may be, for example, a screw or a bolt, which is screwed into a corresponding screw hole in the charging cabinet through the only one second through hole 42, thereby fixedly connecting the second pivot part 4 with the charging cabinet. The first pivot part 16 includes two first wings 161, each first wing 161 including a first pivot eyelet, and the second pivot part 4 includes two second wings 41, each second wing 41 includes a second pivot eyelet. The pivot mechanism 30 further includes a pivot pin 3, and the pivot pin 3 passes through the first pivot eyelet and the second pivot eyelet that are aligned with each other, so that the first pivot part 16 is pivotable about the pivot pin 3 relative to the second pivot part 4. In this way, the first pivot part 16 and the second pivot part 4 cooperate with each other, so that the mainbody 6 can pivot relative to the charging cabinet, when the first fixing member 8 is removed, and thus the socket can pivot relative to the charging cabinet.

In one embodiment of the present disclosure, referring to FIG. 2, the pivot mechanism 30 further includes a locking member 2 passing through a locking eyelet on a free end of the pivot pin 3 to prevent the pivot pin 3 from falling off.

In one embodiment of the present disclosure, the socket also includes a flip cover 14 and a flip base 10 provided on the mainbody 6. The flip cover 14 is connected to the flip base 10 through a connecting pin 12 and is swingable relative to the flip base 10. In this way, the flip cover 14 can seal the recess part 17. For example, when the charging gun (not shown) is unplugged from the socket for charging an electric vehicle, the exposed recess part 17 of the socket can be sealed with the flip cover 14, in order to prevent water, dirt, etc. from entering the recess part 17 and to avoid potential hazards such as short circuit of the socket. When it is necessary to insert the charging gun into the socket, the flip cover 14 can be opened to expose the recess part 17, so that the charging gun can be inserted therein.

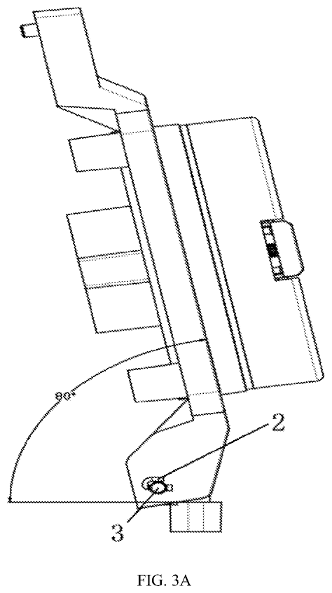

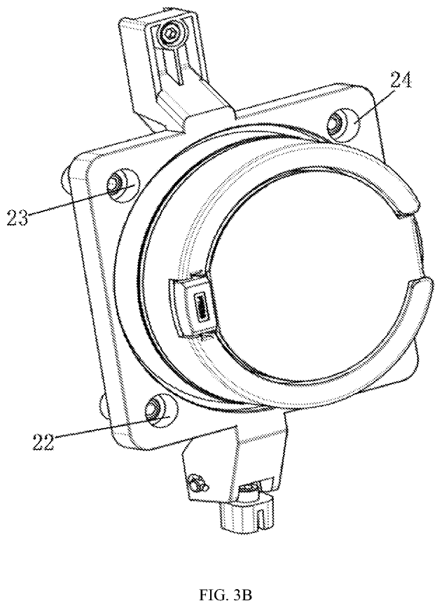

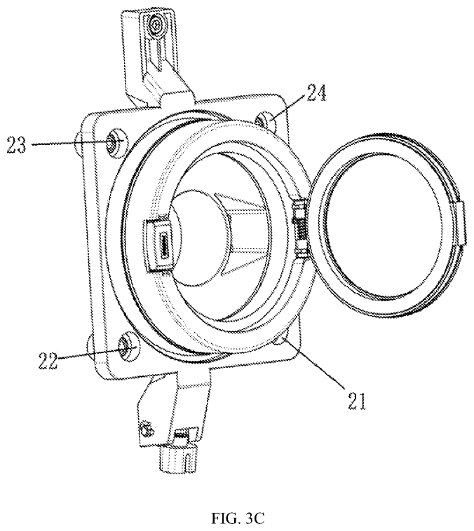

In one embodiment of the present disclosure, the connecting pin 12 passes through a torsion spring 11, and the flip cover 14 can automatically spring up by means of the torsion spring 11. Therefore, when the flip cover 14 is opened, under the elastic force of the torsion spring 11, the flip cover 14 automatically spring up, as shown in FIG. 3C, to quickly expose the recess part 17, thereby facilitating the insertion of the charging gun into the recess part 17.

In one embodiment of the present disclosure, referring to FIG. 2, the flip cover 14 includes a button 7, and the flip cover base 10 includes a snap mechanism 18. When the flip cover 14 closes and seals the recess part 17, the button 7 is locked with the snap mechanism 18 to prevent the flip cover 14 from being opened accidentally. When it is necessary to open the flip cover 14, the button 7 is pressed, and then the lock between the button 7 and the snap mechanism 18 is released, so that the flip cover 14 can be opened. Thus, it is possible to open and close the flip cover 14 conveniently and simply.

In one embodiment of the present disclosure, the snap mechanism 18 includes a button spring 1, and the button 7 is pre-tensioned and locked with the snap mechanism 18 by means of the button spring 1. When the flip cover 14 is opened by pressing the button 7, the pre-tensioned force of the button spring 1 needs to be overcome. Therefore, the button can only be released when the button 7 is pressed to a certain extent, such as when the button 7 is pressed with 17°, the lock between the button 7 and the snap mechanism 18 is released, thereby further preventing the flip cover 14 from being accidentally opened. When the flip cover 14 is closed, the pre-tensioned force of the button spring 1 is used to reliably lock the button 7 with the snap mechanism 18.

In one embodiment of the present disclosure, the flip cover 14 includes a sealing ring 13 on its inner side facing the flip base 10, and the sealing ring 13 is adapted to sealed contact with the flip base 10. The flip base 10 includes a sealing gasket 9 on its bottom side facing the mainbody 6, and the sealing gasket 9 is adapted to sealed contact with the mainbody 6. Through the sealing ring 13 and the sealing gasket 9, it is able to further prevent water, dirt, etc. from entering the socket, thereby improving the sealing performance of the socket and reducing potential safety hazards.

It should be noted that the above embodiments are only exemplary embodiments of the present disclosure, and the present disclosure is not limited to the introduced embodiments. For example, the connection mechanism can be implemented by opening a through hole on one side of the mainbody 6. In this case, only one fixing member 8 can be inserted into the corresponding eyelet of the mainbody 6 through the through hole. For another example, the pivot mechanism 30 can be implemented by a hinge, and its two legs or wings are respectively fixed on the mainbody 6 and the charging cabinet. The two legs or wings can pivot relative to each other, so that the socket can also pivot relative to the charging cabinet.

From the disclosure and teaching presented in the foregoing descriptions and drawings, many modifications and other implementations will come to those skilled in the relevant art. Therefore, it is to be understood that the embodiments of the present disclosure are not to be limited to the specific embodiments disclosed herein, and modifications and other embodiments are also included in the present disclosure. Furthermore, while the above description and drawings describe example embodiments in the context of certain example combinations of components and/or functions, it should be appreciated that different combinations of components and/or functions may be provided by alternative embodiments without departing from the scope of the present disclosure. In this regard, for example, other combinations of components and/or functions than those expressly described above are also contemplated to be within the scope of the present disclosure. Although specific terms are used herein, they are used in a generic and descriptive sense and are not intended to be limiting.

1. A socket with a fixing device, the fixing device comprising:
a connection mechanism, which is provided on one side of a mainbody of the socket and is adapted to releasably connect the socket to a mounting object to which the socket is to be mounted by means of a first fixing member; and
a pivot mechanism which is provided between the other side of the mainbody opposite to the connection mechanism and the mounting object, so that the socket is pivotable relative to the mounting object when released from the mounting object.

2. The socket according to claim 1, wherein the connection mechanism comprises a first through hole, and wherein the first fixing member is adapted to extend into the mounting object through the first through hole, so that the connection mechanism is releasably connected to the mounting object.

3. The socket according to claim 1, wherein the pivot mechanism comprises:
a first pivot part, which is provided on the mainbody; and
a second pivot part, which is fixed on the mounting object by means of a second fixing member;
wherein the first pivot part and the second pivot part cooperate with each other, so that the mainbody is pivotable relative to the mounting object when the first fixing member is removed.

4. The socket according to claim 3, wherein the first pivot part comprises two first wings, each first wing including a first pivot eyelet, and wherein the second pivot part comprises two second wings, each second wing includes a second pivot eyelet,
the pivot mechanism further comprises a pivot pin passing through the first pivot eyelet and the second pivot eyelet that are aligned with each other, so that the first pivot part is pivotable about the pivot pin relative to the second pivot part.

5. The socket according to claim 4, wherein the pivot mechanism further comprises a locking member passing through a locking eyelet on a free end of the pivot pin to prevent the pivot pin from falling off.

6. The socket according to claim 3, wherein the second pivot part comprises a second through hole and wherein the second fixing member is adapted to extend into the mounting object through the second through hole, so that the second pivot part is fixedly connected to the mounting object.

7. The socket according to claim 1, wherein the socket is a socket for an electric vehicle charging gun, and wherein the mounting object is a charging cabinet of the electric vehicle charging gun.

8. The socket according to claim 1, wherein the socket further comprises:
a recess part, which is adapted to at least partially accommodate an insertion object; and
a flip cover, which is adapted to close the recess part when the insertion object is not inserted into the recess part.

9. The socket according to claim 8, wherein the socket further comprises a flip base provided on its mainbody, and wherein the flip cover is connected to the flip base through a connecting pin and is swingable relative to the flip base.

10. The socket according to claim 9, wherein the connecting pin passes through a torsion spring, and wherein the flip cover can automatically spring up by means of the torsion spring.

11. The socket according to claim 9, wherein the flip cover comprises a button comprises a snap mechanism, and wherein the button is adapted to lock with the snap mechanism.

12. The socket according to claim 11, wherein the snap mechanism comprises a button spring, and wherein the button is pre-tensioned and locked with the snap mechanism by means of the button spring.

13. The socket according to claim 8, wherein the flip cover comprises a sealing ring on its inner side facing the flip base 44 and wherein the sealing ring is adapted to sealed contact with the flip base.

14. The socket according to claim 9, wherein the flip base comprises a sealing gasket on its bottom side facing the mainbody, and wherein the sealing gasket is adapted to sealed contact with the mainbody.

15. A charging cabinet for electric vehicles comprising the socket according to claim 1.
